(19) United States
(12) Patent Application Publication
(10) Pub. No.: US 2023/0129307 A1
(43) Pub. Date: Apr. 27, 2023

(54) RE-ESTABLISH CONNECTION WITH DOCKING STATIONS

(71) Applicant: Hewlett-Packard Development Company, L.P., Spring, TX (US)

(72) Inventors: Chun Chang, Taipei City (TW); Ming-Hong Lee, Taipei City (TW); Anand Kulkarni, Spring, TX (US); Li-Pin Lu, Taipei City (TW); Rajesh Shah, Spring, TX (US)

(21) Appl. No.: 17/511,886

(22) Filed: Oct. 27, 2021

(51) Int. Cl. G06F 11/14; G06F 1/16

(52) U.S. Cl. CPC G06F 11/1443; G06F 1/1632; G06F 2201/85

(57) ABSTRACT

In some examples, the disclosure describes a device that includes a docking station and a processor. The processor may determine that an error condition involving disconnection of a computing device from the docking station couplable to the computing device has occurred and receive, responsive to the determination, a signal indicative of performance of an operation to re-establish communication with the docking station. The processor may further perform, responsive to receipt of the signal, the operation to re-establish communication with the docking station.

### BACKGROUND

A host computing device can connect to a docking station to transfer power signals and/or other signaling between the docking station and the computing device. Docking stations can include ports to facilitate connection between the docking station and the host computing device and/or peripheral computing components.

### BRIEF DESCRIPTION OF THE DRAWINGS

FIG. 1 illustrates an example of a device to re-establish connection with a docking station.

FIG. 2 illustrates an example of a device to re-establish a connection with a docking station.

FIG. 3 illustrates an example flow diagram to re-establish a connection with a docking station.

FIG. 4 is an example of a controller to re-establish a connection with a docking station.

FIG. 5 is a block diagram of an example system to re-establish a connection with docking a station.

### DETAILED DESCRIPTION

A computing device (or a “computing device,” for brevity) may be utilized for various purposes, such as for business and/or recreational use. Non-limiting examples of a computing device may include host computing devices and/or peripheral computing devices. As used herein, the term “computing device” refers to an electronic device having a processor and a memory resource. In general, the processor of a “host computing device” may be a central processing unit (CPU) that includes a complex instruction set computer (CISC) that may utilize an x86 or similar instruction set architecture (ISA). A host computing device may further execute an operating system, in contrast to a computing device such as a peripheral computing device. Examples of host computing devices include, for instance, a laptop computer, a notebook computer, a desktop computer, and/or a mobile device (e.g., a smart phone, tablet, personal digital assistant, smart glasses, a wrist-worn device, etc.), among other types of computing devices, while examples of computing devices such as peripheral computing devices include, for instance, docking stations, pointing devices, keyboards, and other computing devices that may not include a CISC architecture and/or may not execute an operating system.

A host computing device may be couplable to a peripheral computing device, such as a docking station. As used herein, the term “docking station” refers to an electronic device that, when a host computing device is connected thereto, permits the host computing device to connect to multiple peripherals using a single connection (e.g., a Universal Senal Bus connection) between the host computing device and a docking station. In addition, a docking station may provide power signals and/or data signals to the host computing device. A docking station can include a processor (e.g., a controller such as an embedded controller) and a memory resource. In general, the processor of a docking station may be a processing unit that includes a reduced instruction set computer (RISC) that may utilize an advanced RISC machine (ARM) ISA or other RISC architecture. As part of providing power signal and/or data signals to the host computing device, a docking station may also provide power to the host computing device to charge the host computing device when the host computing device is connected the docking station.

A docking station may include a locking mechanism (or a portion thereof) to secure a physical connection between the host computing device and the docking station when the host computing device and the docking station are connected (e.g., when the host computing device and the docking station are physically connected to one another). Similarly, the host computing device may include a locking mechanism (or a portion thereof) to facilitate secure physical connection between the host computing device and the docking station when the host computing device and the docking station are connected. As used herein, the term “locking mechanism” refers to a mechanical device or other physical contrivance that operates to provide a secure physical coupling between the host computing device and the docking station. The locking mechanisms described herein are generally operated (e.g., engaged or disengaged) based on signaling generated by the host computing device and/or the docking station.

Due to the mechanical nature of locking mechanisms, and due to such locking mechanisms being generally operated based on signaling generated by the host computing device and/or the docking station, locking mechanisms may experience errors or failures during operation. For example, during operation of a locking mechanism, the locking mechanism may fail to respond to commands to either engage or disengage. In the event that the locking mechanism fails during operation, a user may not be able to safely remove the host computing device from the docking station. This may result in data written to the host computing device being lost. In addition, a user of the host computing device may lose valuable time in attempting to troubleshoot such issues, which, in some approaches can include the use of brute force and/or hand tools that may damage the host computing device and/or the docking station. These and other issues that may arise when the locking mechanism fails can result in a poor experience for a user of the host computing system and/or the docking station.

The present disclosure generally relates to recovery of errors involving docking stations that may cause the docking station to fail in a state in which a host computing device is in an engaged or “locked state” with respect to the docking station. More specifically, the present disclosure relates to performance of error recovery operations to cause the host computing device to be safely unlocked from the docking station if it is determined that an error or failure has occurred that has caused the host computing device to remain in the locked state with respect to the docking station, or vice versa.

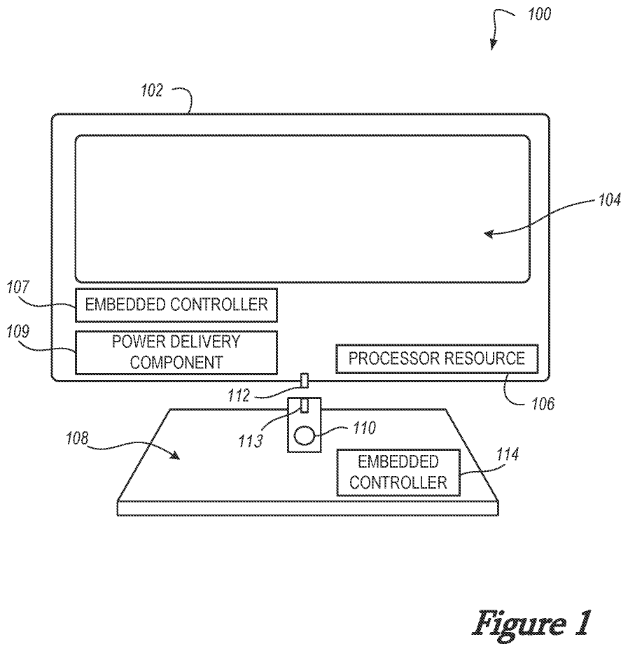

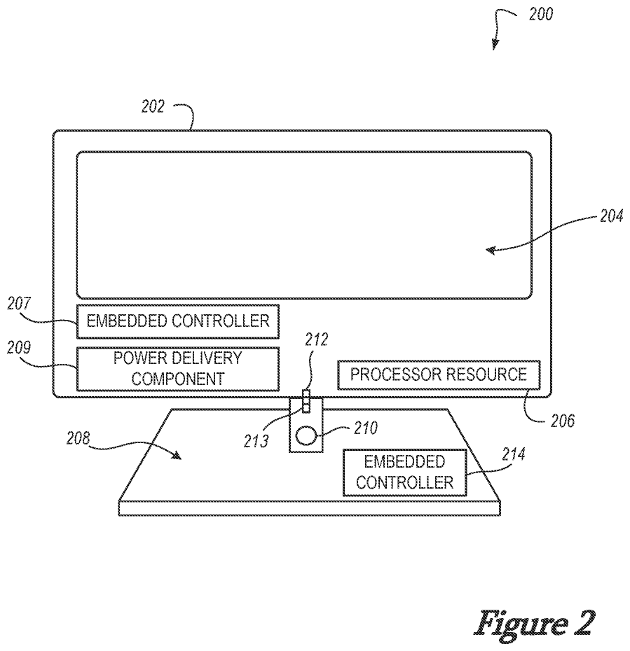

FIG. 1 illustrates an example of a device 100 to re-establish a connection with a docking station 108. The device 100 illustrated in FIG. 1 includes a host computing device 102, which includes a display device 104, a processor resource 106, an embedded controller 107, and a power delivery controller 109. The host computing device 102 further includes a first portion of a locking mechanism 112 that may be operatable to couple the host computing device 102 to a docking station 108. As shown in FIG. 1, the docking station 108 includes an embedded controller 114 and a second portion of the locking mechanism 113. As described in more detail in connection with FIG. 2, herein, the first locking mechanism 112 and the second locking mechanism 113 can physically couple to one another to lock the host computing device to the docking station 108.

As shown in FIG. 1, the docking station 108 includes a release mechanism 110 that can be actuated to cause the first locking mechanism 112 and the second locking mechanism 113 to be disengaged to allow removal of the host computing device 102 from the docking station 108. In some examples, actuation of the release mechanism 110 causes signals to be generated by the host computing device 102 and/or the docking station 108 that cause the first locking mechanism 112 and the second locking mechanism 113 to become disengaged, thereby allowing for the host computing device 102 to be safely removed from the docking station 108. Although not explicitly shown in FIG. 1, so as to not obfuscate the drawings, the release mechanism 110 can include an indicator, such as a light emitting diode (LED) that is generally illuminated when the host computing device 102 is coupled to the docking station 108 and is generally not illuminated when the host computing device 102 is not coupled to the docking station 108.

As described above, the host computing device 102 can be a laptop computer, a notebook computer, a desktop computer, and/or a mobile device. Accordingly, in some examples, the processor resource 106 can be a CPU that includes a CISC. In some examples, the processor resource 106 may include at least a portion of the power delivery controller 109 and/or at least a portion of the embedded controller 107. As used herein, the term “power delivery controller”' refers to an integrated circuit that includes components that facilitate transfer of power signals and/or data signals to the host computing device 102 over a single cable, such as a Universal Serial Bus (e.g., a Type-C Universal Serial Bus) cable. Further, as used here, the term “embedded controller” refers to a microcontroller that handles various system tasks that are generally not handled by an operating system of the host computing device 102.

FIG. 2 illustrates another example of a device 200 to re-establish a connection with a docking station. The device 200 illustrated in FIG. 2 includes a host computing device 202, which includes a display device 204, a processor resource 206, an embedded controller 207, and a power delivery controller 209. The host computing device 202 further includes a first portion of a locking mechanism 212 that couples the host computing device 202 to a docking station 208. As shown in FIG. 2, the docking station 208 includes an embedded controller 214 and a second portion of the locking mechanism 213.

The device 200 can be analogous to the device 100 illustrated in FIG. 1, herein. Accordingly, the computing device 202, the display device 204, the processor resource 206, the embedded controller 207, the power delivery controller 209, the docking station 208, the release mechanism 210, the locking mechanisms 212 and 213, and the embedded controller 214 can be analogous to the computing device 102, the display device 104, the processor resource 106, the embedded controller 107, the power delivery controller 109, the docking station 108, the release mechanism 110, the locking mechanism 112 and 113, and the embedded controller 114 illustrated in FIG. 1, herein.

As shown in FIG. 2, the host computing device 202 is coupled to the docking station 208. That is, the locking mechanisms 212 and 213 (e.g., the first locking mechanism 212 and the second locking mechanism 213) are engaged such that the host computing device 202 is locked to the docking station 208. While the host computing device 202 is coupled to the docking station 208, the host computing device 202 and/or the docking station 208 can transfer signals between one another. Non-limiting examples of signals that can be transferred between the host computing device 202 and the docking station may include power signals (e.g., signals to provide power to and/or to charge the host computing device), signals to operate peripheral devices that may be coupled to the docking station 208, signals to operate the locking mechanism 212 and 213, and/or other communication signals to facilitate operation of the host computing device 202 while the host computing device is coupled to the docking station 208.

During normal operation of the host computing device 202 while the host computing device 202 is coupled to the docking station 208, the release mechanism 210 may be actuated in order to cause the locking mechanisms 212 and 213 to be disengaged to allow the host computing device 202 to be decoupled (e.g., removed) from the docking station 208. However, from time to time the locking mechanisms 212 and 213 may remain engaged despite actuation of the release mechanism 210. In addition, or in the alternative, the locking mechanisms 212 and 213 may experience an error or fail (e.g., experience an “error condition”) in an engaged position after the host computing device 202 has been coupled to the docking station 208 for a particular amount of time (e.g., after hours or days). Sometimes when the locking mechanisms 212 and 213 experience such an error or fail in the engaged position, the indicator of the docking station 208 described above in connection with FIG. 1 may not be illuminated, indicating that the locking mechanisms 212 and 213 are disengaged despite the locking mechanisms 212 and 213 remaining engaged.

In order to mitigate and/or correct this phenomenon, aspects of the present disclosure allow for performance of operations executed by the processor resource 206, the embedded controller 207, the power delivery controller 209, and/or the embedded controller 214 to return the host computing device 202 and/or the docking station 208 to a state in which the host computing device 202 can be decoupled from the docking station 208. For example, when it is determined that a condition in which the locking mechanisms 212 and/or 213 have failed such that the locking mechanisms 212 and 213 remain engaged, the processor resource 206, the embedded controller 207, the power delivery controller and/or the embedded controller 214 can perform operations to re-establish communication between the host computing device 202 and the docking station 208 to allow for the locking mechanisms 212 and 213 to be disengaged.

In a non-limiting example, a device 200 includes a docking station 208 and a processor (e.g., the processor resource 206, the embedded controller 207, and/or the power delivery controller 209) to determine that an error condition involving disconnection of a computing device 202 from the docking station 208 couplable to the computing device 202 has occurred. In some examples, the error condition involving disconnection of the computing device 202 from the docking station 208 comprises a condition in which a locking mechanisms 212 and/or 213 associated with the computing device 202 or the docking station 208, or both, remains in an engaged state.

The processor may receive, responsive to the determination, a signal (e.g., one or more signals or “signaling”) indicative of performance of an operation to re-establish communication with the docking station 208 and perform, responsive to receipt of the signal, the operation to re-establish communication with the docking station 208. As described herein, the processor may include at least a portion of a power delivery controller 209. Examples are not so limited, however, and in some examples, the power delivery controller 209 and/or the embedded controller 207 may receive, responsive to the determination, a signal indicative of performance of an operation to re-establish communication with the docking station 208 and perform, responsive to receipt of the signal, the operation to re-establish communication with the docking station 208.

The processor may cause data corresponding to a previously established connection (e.g., a connection that was established while the computing device 202 is coupled to the docking station 208 prior to the determination that the error condition involving disconnection of the computing device 202 from the docking station 208 occurred) between the computing device 202 and the docking station 208 to be deleted as part of performance of the operation to re-establish communication with the docking station 202. For example, data corresponding to a previously established connection between the computing device 202 and the docking station 208 may become corrupted while the computing device 202 is coupled to the docking station 208, leading to the error condition involving disconnection of the computing device 202 from the docking station 208. In order to remediate the error condition, the corrupted data may be deleted as part of performance of the operation to re-establish communication with the docking station 208.

In some examples, the processor may perform the operation to re-establish communication with the docking station 208 in the absence of a signal additional to the signal indicative of performance of the operation to re-establish communication with the docking station 208. For example, the processor may perform the operation to re-establish communication with the docking station 208 to automatically generate a signal that can be transferred between the host computing device 202 and the docking station 208 in response to determining that the error condition involving disconnection of the computing device 202 from the docking station 208 has occurred.

Continuing with this example, the processor may cause at least one of the locking mechanisms 212 and/or 213 coupling the computing device 202 to the docking station 208 to be activated or deactivated in response to successful performance of the operation to re-establish communication with the docking station 208. For example, if the error condition involving disconnection of the computing device 202 from the docking station 208 is characterized by the locking mechanism 212 and/or 213 failing in an engaged state such that the computing device 202 is not decouplable from the docking station 208, the processor may cause (e.g., by generating and/or asserting a signal to the locking mechanism(s) and/or to circuitry that controls the locking mechanism(s)) the locking mechanisms 212 and/or 213 to be deactivated in response to successful performance of the operation to re-establish communication with the docking station 208 such that the computing device 202 can be decoupled from the docking station 208.

In another non-limiting example, a system includes a computing device 202 comprising a power delivery controller 209, a docking station 208 comprising an embedded controller 214, and a locking mechanism 212 and/or 213 to couple to the computing device 202 to the docking station 208. The power delivery controller 209 and/or the embedded controller 214 may, individually or in concert, perform operations related to re-establish connections with docking stations.

For example, the power delivery controller 209 and/or the embedded controller 214 may determine that an error condition involving disconnection of the computing device 202 from the docking station 208 in which the locking mechanism 212 and/or 213 exhibits an abnormal engaged state has occurred. As used herein, the term “abnormal engaged state” refers to a state in which the locking mechanism remains engaged when the locking mechanism should be disengaged. An “abnormal engaged state” may be indicative of a failure or error involving the locking mechanism 212 and/or 213.

The power delivery controller 209 and/or the embedded controller 214 may generate, responsive to the determination, a signal or signaling indicative of performance of an operation to re-establish communication between the computing device 202 and the docking station 208, as described herein.

Continuing with this example, the power delivery controller 209 and/or the embedded controller 214 may perform, responsive to receipt of the signal or signaling, the operation to re-establish communication between the computing device 202 and the docking station 208 to cause the locking mechanism 212 and/or the locking mechanism 213 coupling the computing device 202 to the docking station 208 to exhibit a normal engaged state. As used herein, the term “normal engaged state” refers to a state in which the locking mechanism(s) remains engaged when the locking mechanism(s) should be engaged. For example, the abnormal engaged state may comprise a state in which the locking mechanism (e.g., the locking mechanism 212 and/or the locking mechanism 213) is activated when the computing device expects that the locking mechanism is deactivated, and the normal engaged state may comprise a state in which the locking mechanism (e.g., the locking mechanism 212 and/or the locking mechanism 213) is activated while the computing device and the docking station are in communication with one another.

The states of the computing devices (e.g., the host computing device 202 and/or the docking station 208) can, in some examples, affect the normal engaged state and/or the abnormal engaged state. For instance, the host computing device 202 can be in a state that is receptive to initialization of a first connection to the docking station 208, or vice versa. In other examples, the host computing device 202 can be in a state that is not receptive to initialization of a first connection to the docking station 208, or vice versa. Further, the host computing device 202 and/or the docking station 208 can be in states that change based on an amount of time to which the host computing device 202 is connected to the docking station 208, among other possible states, such as operating states (e.g., sleep modes, operational modes, etc. of the host computing device 202 and/or the docking station 208).

In some examples, the power delivery controller 209 and/or the embedded controller 214 may determine that at least a portion of data written to the power delivery controller 209 that corresponds to a previously established connection between the computing device 202 and the docking station 208 is corrupt. For example, the power delivery controller 209 and/or the embedded controller 214 may determine that, while the computing device 202 and the docking station 208 were coupled via the locking mechanisms 212 and/or 213 and in communication with one another, an error occurred that is causing the locking mechanisms 212 and/or 213 to exhibit the abnormal locked state, In some examples, such errors can result from corrupt data written to the power delivery controller 209, the embedded controller 207, and/or the processor resource 206.

Accordingly, in some examples, the power delivery controller 209 and/or the embedded controller 214 may cause the corrupt data to be deleted as part of performance of the operation to re-establish communication with the docking station 208. By deleting the corrupt data, the operation to re-establish communication between the computing device 202 and the docking station 208 can be performed using a “clean slate” (e.g., free from corrupt data) of memory associated with the power delivery controller 209, the embedded controller 207, and/or the processor resource 206, Deletion of the corrupt data to achieve such a “clean state” can include deletion of corrupt data that is locally stored by memory associated with the power delivery controller 209 and/or the embedded controller 214, among other possible memory that may store such corrupted data.

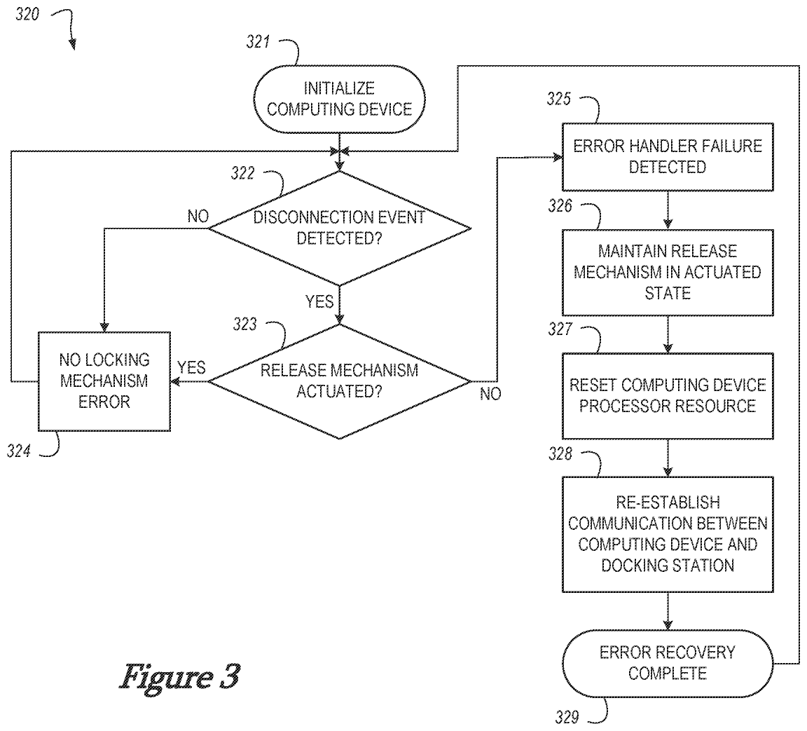

Continuing with this example, the power delivery controller 209 and/or the embedded controller 214 may perform an operation to re-establish signaling indicative of electrical power transfer or signaling indicative of data transfer, or both, between the computing device 202 and the docking station 208 as part of performance of the operation to re-establish communication between the computing device 202 and the docking station 208. The operation to re-establish signaling indicative of electrical power transfer or signaling indicative of data transfer, or both, between the computing device 202 and the docking station 208 can be performed to initialize the computing device 202 and/or docking station 208, as described in more detail in connection with FIG. 3, herein.

In some examples, the power delivery controller 209 and/or the embedded controller 214 may determine that the error condition has occurred, generate the signaling indicative of performance of the operation to re-establish communication between the computing device and the docking station, and perform the operation to re-establish communication between the computing device and the docking station in the absence of a command generated external to the computing device and the docking station. For example, the power delivery controller 209 and/or the embedded controller 214 may perform these and other operations automatically and/or without user input in response to determining that the error condition has occurred.

FIG. 3 illustrates an example flow diagram 320 to re-establish connections with docking stations. At operation 321, the flow 320 may include initialization of a computing device. The computing may be analogous to the host computing device 102 and/or the host computing device 202 illustrated in FIGS. 1 and 2, herein. In some examples, the computing device is initialized in response to being coupled to a docking station, such as the docking station 108 and/or the docking station 208 illustrated in FIGS. 1 and 2, herein. Initialization of the computing device can include establishing communication with the docking station, which can include transfer of signals (e.g., power signals, data signals, signals to initialize peripherals connected to the docking station, etc., as described above) and/or can include engagement of a locking mechanism, such as the locking mechanisms 112 and/or 113 illustrated in FIG. 1, herein and/or the locking mechanisms 212 and/or 213 illustrated in FIG. 2, herein.

At operation 322, the flow 320 may include detecting whether a disconnection event has occurred. The disconnection event may be performed to safely disconnect the computing device from the docking station such that the computing device can be removed from the docking station, as described above. The disconnection event may include actuation of a release mechanism (e.g., the release mechanism 110 and/or the release mechanism 210 illustrated in FIGS. 1 and 2, herein) of the docking station and/or the disconnection event may include transfer of signaling from the computing device to the docking station indicating that the computing device has received signaling indicative of a disconnection event. Accordingly, the disconnection event can include transfer of signals between the computing device and the docking station and/or operations to disengage the locking mechanism coupling the computing device to the docking station. If a disconnection event is not detected, the flow 320 continues to operation 324, where it is determined that an error involving the locking mechanism has not occurred.

If it is determined at operation 322 that a disconnection event has been detected, the flow 320 continues to operation 323, where it is determined whether the release mechanism has been actuated. If the release mechanism has been actuated, the flow 320 continues to operation 324, where it is determined that an error involving the locking mechanism has not occurred.

If, however, it is determined that the release mechanism has not been actuated, the flow 320 continues to operation 325, where it is determined that an error handler failure is detected. As used herein, the term “error handler” refers to a routine or set of routines that are executed by a computing device in response to detection of an abnormal input or condition experienced by the computing device. Accordingly, when an error handler failure is detected, the computing device may determine that additional operations may be performed to correct the failure or error condition.

In some examples, operations performed in connection with the error handler can include operations to determine whether an error involving the locking mechanism has or has not occurred. Examples are not so limited, however, and it is contemplated that operations performed in connection with the error handler can include operations to determine whether other errors have occurred within the computing device and/or the docking station. It will be appreciated that instructions executable to perform operations in connection with the error handler can be updated to (e.g., via firmware updates, operating system updates, or other such updates) alter the functionality of the error handling routines described herein.

In the example of FIG. 3, the failure or error condition may be the occurrence of a failure or error involving the locking mechanism (e.g., a condition in which the locking mechanism remains engaged when the locking mechanism should be disengaged) and the error handler failure may refer to a condition in which the routines or set of routines executed by the computing in response to detection of the abnormal input or condition (e.g., the condition in which the locking mechanism remains engaged when the locking mechanism should be disengaged) do not correct the failure or error condition (e.g., the error handler is unable to cause the locking mechanism to become disengaged).

Subsequent to detection of the error handler failure, the flow 320 can continue to operation 326 where the release mechanism is maintained in an actuated state. For example, in order to attempt to remediate the failure or error involving the locking mechanism, the release mechanism can be maintained in an actuated state such that the computing device and/or the docking station operate as if the release mechanism is in an actuated state.

At operation 327, the processor resource (e.g., the processor resource 106 and/or the processor resource 206 illustrated in FIGS. 1 and 2, herein) of the computing device can be reset. In examples in which the processor resource includes at least a portion of a power delivery controller, the power delivery controller can be reset, Similarly, in examples in which the processor resource includes at least a portion of an embedded controller, the embedded controller can be reset. In some examples, operations to reset the power delivery controller and/or the embedded controller can be performed by executing, by the processor resource, the embedded controller, and/or the power delivery controller, instructions to reset the power delivery controller and/or the embedded controller in response to the occurrence of the failure or error involving the locking mechanism, as described here. In some examples, the embedded controller (e.g., the embedded controller 114 and 214 illustrated in FIGS. 1 and 2, herein) of the docking station may generate signals and transfer the signals to the host computing device to facilitate resetting the processor resource of the computing device.

In some examples, resetting the processor resource, the embedded controller, and/or the power delivery controller (or portions thereof) of the computing device can include deletion of data stored by registers of the processor resource, the embedded controller, and/or the power delivery controller. Such data may have been corrupted during operation of the computing device while the computing device was coupled to the docking station and may therefore have given rise to the occurrence of the failure or error involving the locking mechanism. By deleting such data, it may be possible to remediate the failure or error involving the locking mechanism.

At operation 328, communication between the computing device and the docking station may be re-established. In some examples, communication between the computing device and the docking station may be re-established by transferring signaling between the docking station (e.g., between the embedded controller of the docking station) and the computing device (e.g., a power delivery controller of the computing device and/or an embedded controller of the computing device). The signaling transferred between the computing device and the docking station at operation 328 can include signaling similar to the signaling at operation 321 to initialize the computing device and can therefore include establishing communication with the docking station, which can include transfer of signals (e.g., power signals, data signals, signals to initialize peripherals connected to the docking station, etc., as described above).

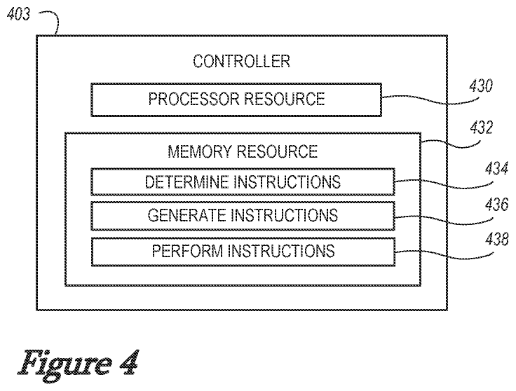

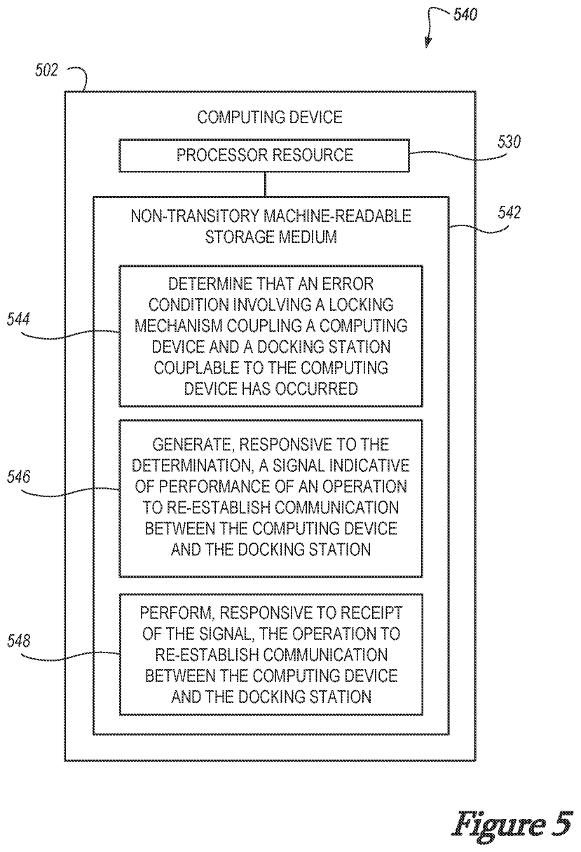

FIG. 4 is an example of a controller 403 to re-establish connections with docking stations. As described herein, the controller 403 may perform functions related to re-establishment of a connection between a computing device and a docking station. The controller 403 may include a processor resource 430 and a machine-readable storage medium (e.g., the machine-readable medium 542 illustrated in FIG. 5, herein). Although the following descriptions refer to a single processor resource 430 and a single machine-readable storage medium, the descriptions may also apply to a system with multiple processor resources and multiple machine-readable storage mediums. In such examples, the controller 403 may be distributed across multiple machine-readable storage mediums and across multiple processor resources. Put another way, the instructions executed by the controller 403 may be stored across multiple machine-readable storage mediums and executed across multiple processors, such as in a distributed or virtual computing environment.

The processor resource 430 may be a central processing unit (CPU), a semiconductor-based microprocessor, and/or other hardware devices suitable for retrieval and execution of machine-readable instructions 434, 436, 438 stored in a memory resource 432. In some examples, the processor resource 430 may be analogous to the processor resource 106, the embedded controller 107, and/or the power delivery controller 109 illustrated in FIG. 1, herein. The processor resource 430 may fetch, decode, and execute instructions 434, 436, 438. As an alternative or in addition to retrieving and executing instructions 434, 436, 438, the processor resource 430 may include a plurality of electronic circuits that include electronic components for performing the functionality of instructions 434, 436, 438.

The memory resource 432 may be any electronic, magnetic, optical, or other physical storage device that stores executable instructions 434, 436, 438, and/or data. Thus, the memory resource 432 may be, for example, Random-Access Memory (RAM), an Electrically-Erasable Programmable Read-Only Memory (EEPROM), a storage drive, an optical disc, and the like. The memory resource 432 may be disposed within controller 403, as shown in FIG. 4. Additionally, the memory resource 432 may be a portable, external or remote storage medium, for example, that causes the controller 403 to download the instructions 434, 436, 438 from the portable/external/remote storage medium.

The controller 403 may include instructions 434 stored in the memory resource 432 and executable by the processor resource 430 to determine that an error condition involving a locking mechanism (e.g., the locking mechanism 112-1 and 212-1 and/or the locking mechanism 212-1 and 212-2 illustrated in FIGS. 1 and 2, herein) coupling a computing device (e.g., the computing device 102 and/or the computing device 202 illustrated in FIGS. 1 and 2, herein) and a docking station (e.g., the docking station 108 and/or the docking station 208 illustrated in FIGS. 1 and 2, herein) couplable to the computing device has occurred.

The controller 403 may include instructions 436 stored in the memory resource 432 and executable by the processor resource 430 to generate, responsive to the determination, a signal and/or signaling indicative of performance of an operation to re-establish communication between the computing device and the docking station. In some examples, the controller 403 may include instructions 438 stored in the memory resource 432 and executable by the processor resource 430 to perform, responsive to receipt of the signal and/or signaling, the operation to re-establish communication between the computing device and the docking station.

The controller 403 may further include instructions 436 stored in the memory resource 432 and executable by the processor resource 430 to perform the operations described herein. For example, the controller 403 may include instructions 436 stored in the memory resource 432 and executable by the processor resource 430 to perform operations to re-establish connections with docking stations. As described herein, such operations may be performed to remediate failures and/or errors that can occur when a locking mechanism that couples a computing device to a docking station exhibits an abnormal engaged state.

FIG. 5 is a block diagram of an example system 540 to re-establish connections with docking stations. In the example of FIG. 5, system 540 includes a computing device 502 including a processor resource 530 and a non-transitory machine-readable storage medium 542. Although the following descriptions refer to a single processor resource and a single machine-readable storage medium, the descriptions may also apply to a system with multiple processor resources and multiple non-transitory machine-readable storage mediums. In such examples, the instructions may be distributed across multiple machine-readable storage mediums and the instructions may be distributed across multiple processor resources. Put another way, the instructions may be stored across multiple machine-readable storage mediums and executed across multiple processor resources, such as in a distributed computing environment.

The processor resource 530 may be a central processing unit (CPU), microprocessor, and/or other hardware device suitable for retrieval and execution of instructions stored in the non-transitory machine-readable storage medium 542. In the particular example shown in FIG. 5, the processor resource 530 may determine, generate, and perform instructions 544, 546, and/or 548. As an alternative or in addition to retrieving and executing instructions, processor resource 530 may include an electronic circuit comprising a number of electronic components for performing the operations of the instructions in the non-transitory machine-readable storage medium 542. With respect to the executable instruction representations or boxes described and shown herein, it should be understood that part or all of the executable instructions and/or electronic circuits included within one box may be included in a different box shown in the figures or in a different box not shown.

The non-transitory machine-readable storage medium 542 may be any electronic, magnetic, optical, or other physical storage device that stores executable instructions. Thus, the non-transitory machine-readable storage medium 542 may be, for example, RAM, EEPROM, a storage drive, an optical disc, and the like. The executable instructions may be “installed” on the system 540 illustrated in FIG. 5. The non-transitory machine-readable storage medium 542 may be a portable, external or remote storage medium, for example, that allows the system 540 to download the instructions from the portable/external/remote storage medium. In this situation, the executable instructions may be part of an “installation package.”

The determine instructions 544, when executed by a processor resource such as the processor resource 530, may cause the system 540 to determine that an error condition involving a locking mechanism coupling a computing device and a docking station couplable to the computing device has occurred. As described above, the error condition may be indicative of an error or failure detected by a computing device (e.g., the host computing device 102 and/or the host computing device 202 illustrated in FIGS. 1 and 2, herein) and/or a docking station (e.g., the docking station 108 and/or the docking station 208 illustrated in FIGS. 1 and 2, herein) in which the locking mechanism remains engaged when the locking mechanism is supposed to be disengaged.

The generate instructions 546, when executed by a processor resource such as the processor resource 530, may cause the system 540 to generate, responsive to the determination, a signal indicative of performance of an operation to re-establish communication between the computing device and the docking station. As described above, the signal and/or signaling can be transferred between the host computing device and the docking station in preparation of performance of the operation to re-establish communication between the computing device and the docking station.

The perform instruction 548, when executed by a processor resource such as the processor resource 530, may cause the system 540 to perform, responsive to receipt of the signal, the operation to re-establish communication between the computing device and the docking station.

It is contemplated that, instructions not explicitly shown in FIG. 5 may be executed by a processor resource within the scope of the disclosure. For example, instructions executed by a processor resource such as the processor resource 530, may cause the system 540 to cause the processor to cause the locking mechanism coupling the computing device to the docking station to be activated (e.g., engaged) or deactivated (e.g., disengaged) in response to successful performance of the operation to re-establish communication with the docking station.

In some examples, instructions executed by a processor resource such as the processor resource 530, may cause the system 540 to determine that a portion of data corresponding to a previously established connection between the computing device and the docking station is corrupt and/or cause the corrupt data to be deleted as part of performance of the operation to re-establish communication with the docking station, as described above. In some examples, instructions executed by a processor resource such as the processor resource 530, may cause the system 540 to cause the processor resource to re-establish signaling indicative of electrical power transfer or signaling indicative of data transfer, or both, between the computing device and the docking station as part of performance of the operation to re-establish communication between the computing device and the docking station, as described above.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on” “connected to,” “coupled to,” or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements), etc.

The above specification, examples, and data provide a description of the system and methods of the disclosure. Since many examples can be made without departing from the spirit and scope of the system and method of the disclosure, this specification merely sets forth some of the many possible example configurations and implementations.

What is claimed is:

1. A device, comprising:
a docking station; and
a processor to:
determine that an error condition involving disconnection of a computing device from the docking station couplable to the computing device has occurred;
receive, responsive to the determination, a signal indicative of performance of an operation to re-establish communication with the docking station; and
perform, responsive to receipt of the signal, the operation to re-establish communication with the docking station.

2. The device of claim 1, wherein the processor is to cause data corresponding to a previously established connection between the computing device and the docking station to be deleted as part of performance of the operation to re-establish communication with the docking station.

3. The device of claim 1, wherein the processor comprises a portion of a power delivery controller.

4. The device of claim 1, wherein the processor is to perform the operation to re-establish communication with the docking station in the absence of signaling additional to the signal indicative of performance of the operation to re-establish communication with the docking station.

5. The device of claim 1, wherein the processor is to cause a locking mechanism coupling the computing device to the docking station to be activated or deactivated in response to successful performance of the operation to re-establish communication with the docking station.

6. The device of claim 1, wherein the error condition involving disconnection of the computing device from the docking station comprises a condition in which a locking mechanism associated with the computing device or the docking station, or both remains in an engaged state.

7. A non-transitory memory resource storing machine-readable instructions thereon that, when executed, cause a processor resource to:
determine that an error condition involving a locking mechanism coupling a computing device and a docking station couplable to the computing device has occurred;
generate, responsive to the determination, a signal indicative of performance of an operation to re-establish communication between the computing device and the docking station; and
perform, responsive to receipt of the signal, the operation to re-establish communication between the computing device and the docking station.

8. The memory resource of claim 7, wherein the instructions are executed to further cause the processor resource to:
determine that a portion of data corresponding to a previously established connection between the computing device and the docking station is corrupt; and
cause the corrupt data to be deleted as part of performance of the operation to re-establish communication with the docking station.

9. The memory resource of claim 7, wherein the instruction are executed to further cause the processor to cause the locking mechanism coupling the computing device to the docking station to be activated or deactivated in response to successful performance of the operation to re-establish communication with the docking station.

10. The memory resource of claim 7, wherein the instructions are executed to further cause the processor resource to re-establish signaling indicative of electrical power transfer or signaling indicative of data transfer, or both, between the computing device and the docking station as part of performance of the operation to re-establish communication between the computing device and the docking station.

11. A system, comprising:
a computing device comprising a power delivery controller;
a docking station comprising an embedded controller; and
a locking mechanism to couple to the computing device to the docking station, wherein the power delivery controller or the embedded controller, or both, are to:
determine that an error condition involving disconnection of the computing device from the docking station in which the locking mechanism exhibits an abnormal engaged state has occurred;
generate, responsive to the determination, a signal indicative of performance of an operation to re-establish communication between the computing device and the docking station; and
perform, responsive to receipt of the signal, the operation to re-establish communication between the computing device and the docking station to cause the locking mechanism coupling the computing device to the docking station to exhibit a normal engaged state.

12. The system of claim 11, wherein the abnormal engaged state comprises a state in which the locking mechanism is activated when the computing device expects that the locking mechanism is deactivated, and wherein the normal engaged state comprises a state in which the locking mechanism is activated while the computing device and the docking station are in communication with one another.

13. The system of claim 11, wherein the power delivery controller or the embedded controller, or both, are to:
determine that at least a portion of data written to the power delivery controller that corresponds to a previously established connection between the computing device and the docking station is corrupt; and
cause the corrupt data to be deleted as part of performance of the operation to re-establish communication with the docking station.

14. The system of claim 11, wherein the power delivery controller or the embedded controller, or both, are to perform an operation to re-establish signaling indicative of electrical power transfer or signaling indicative of data transfer, or both, between the computing device and the docking station as part of performance of the operation to re-establish communication between the computing device and the docking station.

15. The system of claim 11, wherein the power delivery controller or the embedded controller, or both, are to determine that the error condition has occurred, generate the signal indicative of performance of the operation to re-establish communication between the computing device and the docking station, and perform the operation to re-establish communication between the computing device and the docking station in the absence of a command generated external to the computing device and the docking station.
